(19) United States
(12) Patent Application Publication
(10) Pub. No.: US 2004/0177732 A1
(43) Pub. Date: Sep. 16, 2004

(54) Internal pipe wrench

(76) Inventor: Albert Kile, Danville, IL (US)

Correspondence Address: DAVID J. BREMER, 4518 N. DAMEN AVENUE, CHICAGO, IL, 60525, US

(21) Appl. No.: 10/388,055

(22) Filed: Mar. 13, 2003

(51) Int. Cl. B25B 23/10

(52) U.S. Cl. 81/446

(57) ABSTRACT

The invention is a pipe wrench product for rotating a hollow object, such as a pipe and a tube, by engaging the object interior. The product uses a curvature mis-match between non-similar curvilinear surfaces to control the direction of force transmitted from the product to the object. The product is designed to minimize any distortion to the shape of the object caused by the product and to maximize the turning force transmitted to the object by the product.

The invention is a pipe wrench product for rotating a hollow object, such as a pipe and a tube, by engaging the object interior. The product is designed to minimize any distortion to the shape of the object caused by the product and to maximize the tangential force transmitted to the object by the product.

The product is designed to automatically change the direction and the magnitude of the force transmitted to the pipe according to the force needed to cause the pipe to rotate. Specifically, the product increases the tangential force applied to the pipe faster than the radial force. This enables the product to rotate the pipe without damaging and distorting the pipe.

Other types of pipe wrenches can provide varying amounts of force as needed to rotate the pipe, but the product is unique in its ability to change the magnitude and the direction of the force transmitted to the pipe. The curvature mis-match has been devised in order to minimize the increase in radial force on the pipe after the shoe engages the pipe, and to maximize the tangential force on the pipe.

The product can be used to rotate pipes, tubes and other hollow objects that can be interiorly gripped. For example, there is a need to rotate threaded pipes where the pipes are located in tight spaces. In tight spaces, it can be impractical to use a pipe wrench that grips a pipe around the pipe exterior.

There is also a need to rotate hollow objects that have an exterior surface that would be damaged by an exterior-gripping wrench. The product enables rotating such objects without contacting the exterior surfaces.

Also, the product is well adapted for use with high-speed impact and air tools. The slender profile required to fit inside the pipe reduces rotational inertia of the product, making the product easier to operate at high rotational speeds.

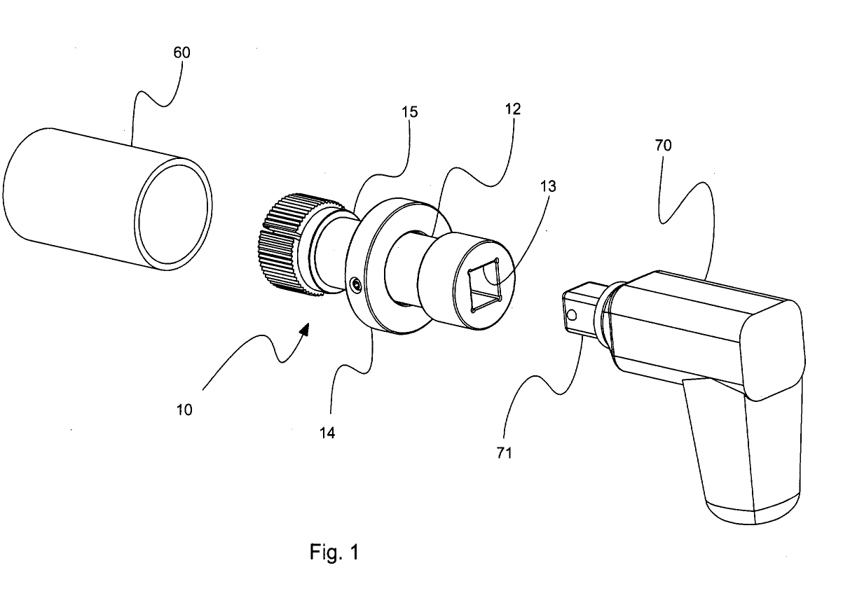

FIG. 1 depicts a perspective view of an assembled product positioned for insertion into a pipe.

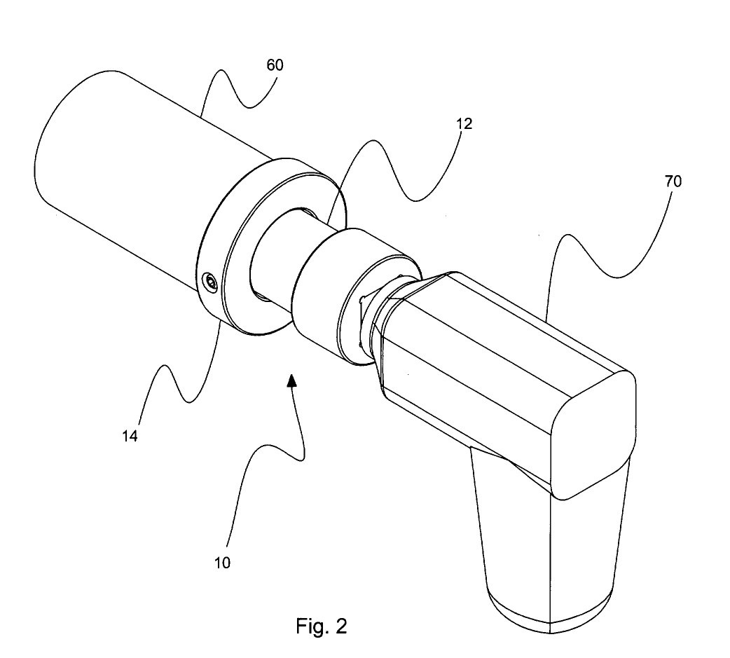

FIG. 2 depicts a perspective view of an assembled product inserted into a pipe.

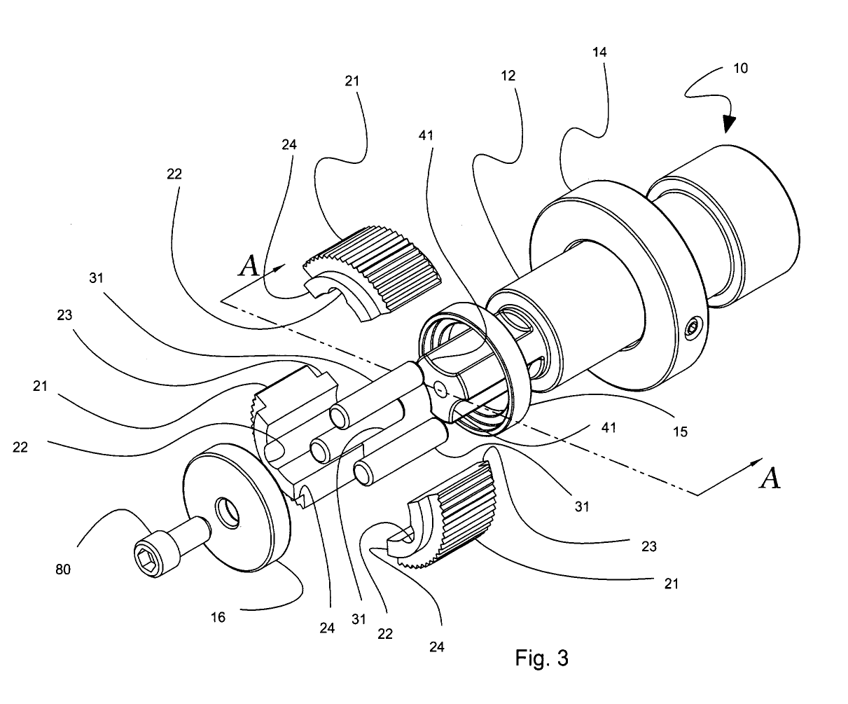

FIG. 3 depicts a perspective exploded view of another product configuration.

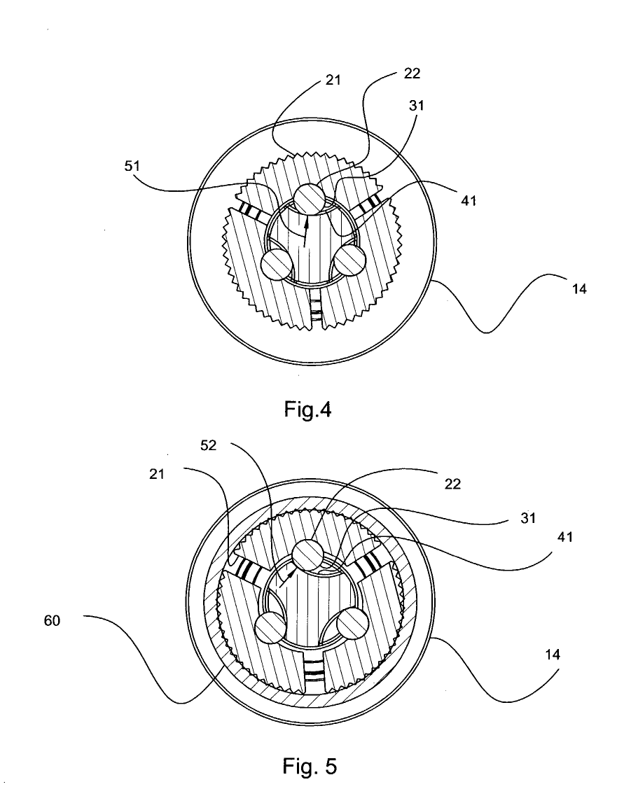

FIG. 4 depicts a section view across line A-A of the product configuration of FIG. 3 in the assembled condition.

FIG. 5 depicts a section view across line A-A of the product configuration of FIG. 3 in use engaging a pipe interior.

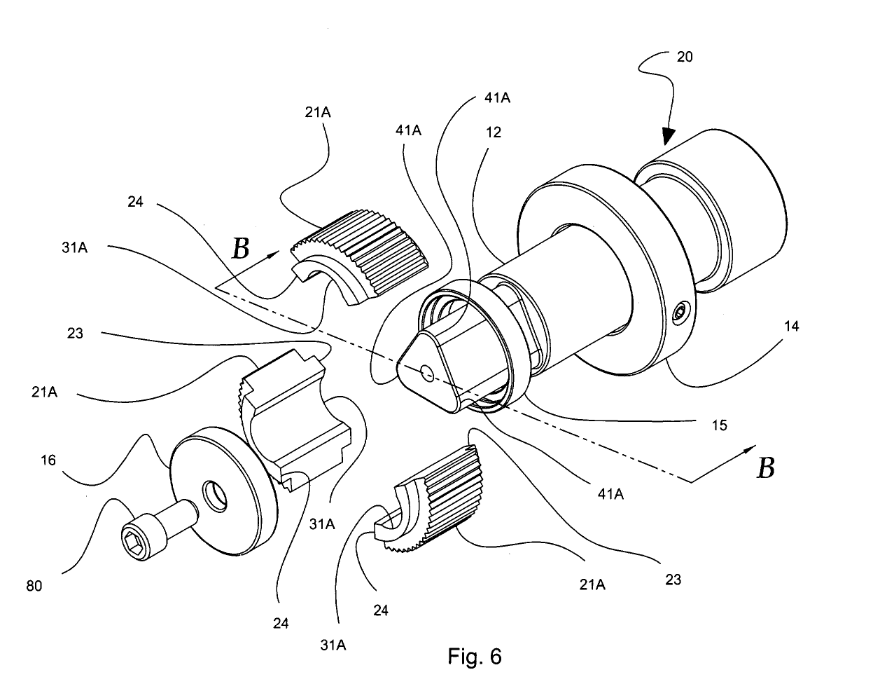

FIG. 6 depicts a perspective exploded view of another product configuration.

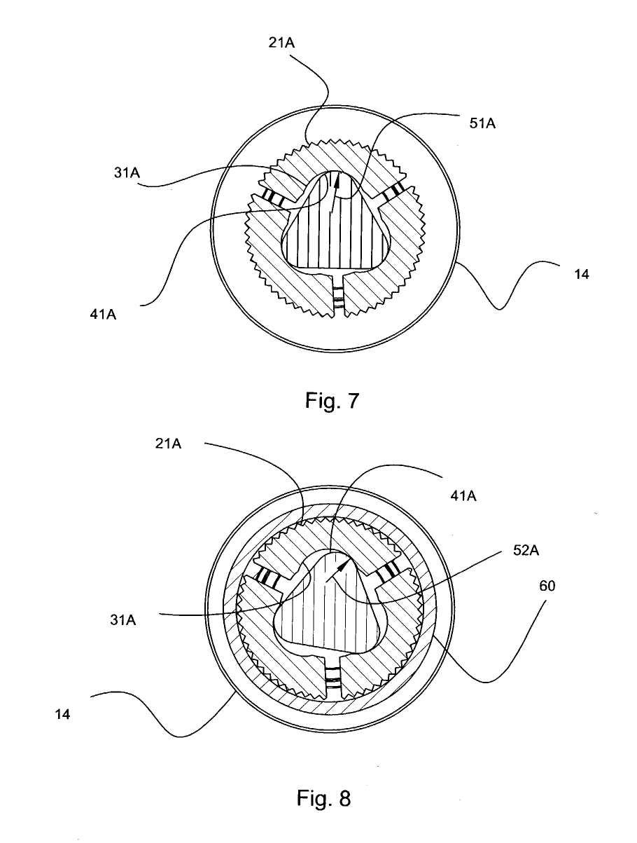

FIG. 7 depicts a section view across line B-B of the product configuration of FIG. 6 in the assembled condition.

FIG. 8 depicts a section view across line B-B of the product configuration of FIG. 6 in use engaging a pipe.

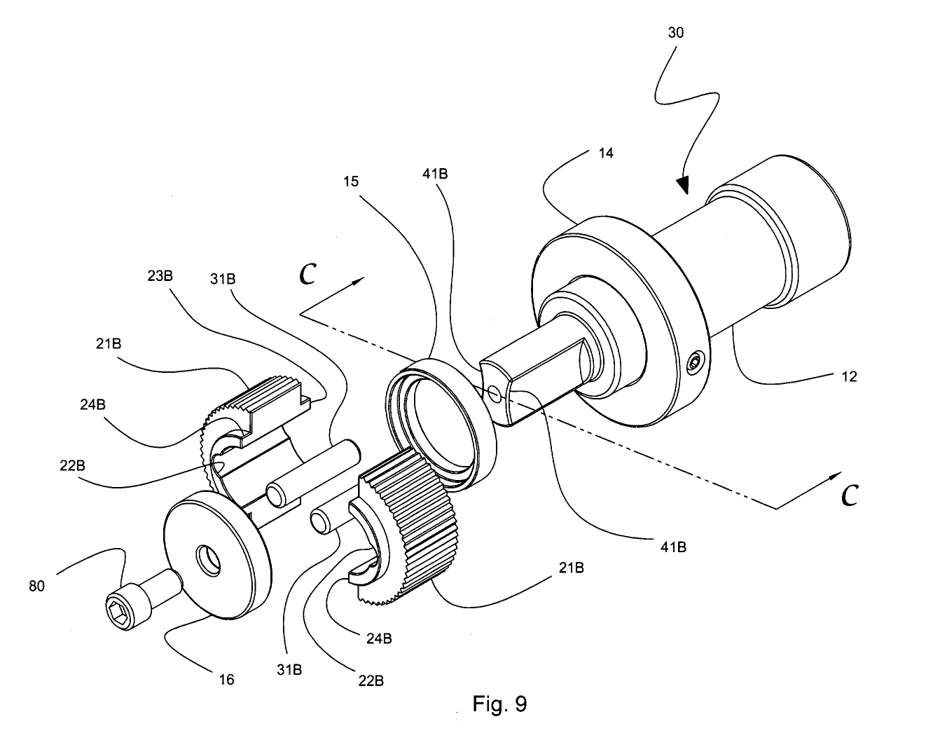

FIG. 9 depicts a perspective exploded view of another product configuration.

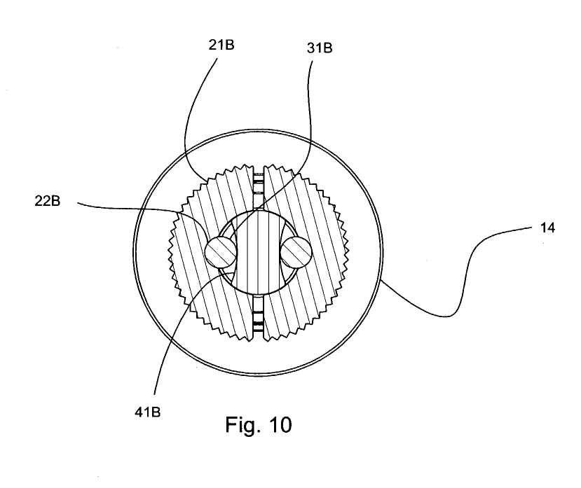

FIG. 10 depicts a section view across line C-C of the product configuration of FIG. 9 in the assembled condition.

The product comprises a rotator and a shoe. In use, at least part of the shoe and the rotator are inserted in a pipe. Then the rotator is rotated from outside the pipe and contacts the shoe. The rotator applies a force on the shoe causing the shoe to rotate with the rotator and causing the shoe to move outwards from the rotator. When the shoe moves outwards it engages the pipe interior and transmits the force to the pipe, causing the pipe to rotate with the rotator.

The product is designed to automatically change the direction and the magnitude of the force transmitted to the pipe according to the force needed to cause the pipe to rotate. Specifically, the product increases the tangential force applied to the pipe faster than the radial force. This enables the product to rotate the pipe without damaging and distorting the pipe.

When the rotator rotates, the rotator and the shoe contact across a first curvilinear surface and at a non-similar second curvilinear surface. The rotator, via the contacting curvilinear surfaces, applies the force to the shoe, which transmits the force to the pipe when the shoe engages the pipe. The curvature mis-match between the curvilinear surfaces provides the contact characteristics that enable the product to change the force.

Other types of pipe wrenches can provide varying amounts of force as needed to rotate the pipe, but the product is unique in its ability to change the magnitude and the direction of the force transmitted to the pipe. The curvature mis-match has been devised in order to minimize the increase in radial force on the pipe after the shoe engages the pipe, and to maximize the tangential force on the pipe.

In FIG. 1, a product 10 is positioned for inserting into a pipe 60. In FIG. 2, the product is inserted into the pipe and prepared to rotate the pipe. In use, a shoe covers a distal end of a rotator, and the distal end and the shoe can be inserted into the pipe until the pipe contacts the adjustable collar 14. The collar 14 slides along a rotator shaft 12 extending from the distal end of the rotator.

A proximal end of the rotator can have a connecter for rotating the rotator from outside the pipe. The rotator can have various types of connecters such as a standard square and hexagonal drive element, a knurled element, and other connecters adapted for rotating by various methods. In FIG. 1 and FIG. 2, the connecter is a square drive pocket 13 for accepting a drive end 71 of an air wrench 70. The air wrench is one method for causing the rotator to rotate. Various methods can be used, such as a ratchet, a breaker bar, a chuck, a vise grip, a wrench, and other methods, as well as rotating by hand.

In FIG. 3, the product 10 is seen in exploded view showing various elements. The product 10 comprises three jaws 21, with three inward-facing seats 22, a curvilinear first surface comprising three first surface components 31, and a rotator. The product 10 has a shoe comprising three shoe components. In this embodiment, a shoe component comprises the jaw 21, the seat 22, and the first surface component 31, because they all move outward from the rotator when the rotator rotates. The product 10 has a non-similar curvilinear second surface comprising three second surface components 41.

The designation of a first surface and of a second surface is a naming convention only and does not indicate their positions nor their connections to the rotator and the shoe. The functional requirements are that the curvilinear surfaces be non-similar and able to move the shoe outward from the rotator when the rotator rotates. In all cases the designations first surface and second surface can be reversed with no effect on the function of the product, so long as the functional requirements are met.

In use, at least part of the shoe and part of the rotator are inserted in the pipe. Then the rotator is rotated in the preferred direction. When the rotator is rotated, the rotator and the shoe contact across the curvilinear first surface and at the non-similar curvilinear second surface. The rotator, via the contacting curvilinear surfaces, applies the force to the shoe.

The force has a forcing direction that is determined by the relative positions of the first surface and the second surface. The forcing direction is along an axis that is normal to the first surface and normal to the second surface where they contact each other.

Initially, when the force is applied, the shoe can move radially and tangentially along the forcing direction until the shoe engages the pipe at the pipe interior. After the shoe engages the pipe, the pipe resists the radial movement and the tangential movement of the shoe. Further rotating the rotator, after the shoe engages the pipe, causes the first surface and the second surface to shift positions and travel across each other.

The design of the mismatched curvilinear first surface and curvilinear second surface causes them to shift their positions when there is resistance to the force on the shoe, such as the resistance caused by inertia and the resistance caused by the pipe resisting the movement of the shoe. The mismatched first surface and second surface are designed to shift positions so that the forcing direction turns more tangential when there is resistance to the force on the shoe.

By turning the forcing direction more tangential, the product reduces the ratio of radial force to tangential force on the shoe. This reduces the likelihood of excessive radial force causing distortion and damage to the pipe. Also, turning the forcing direction more tangential increases the amount of tangential force transmitted to the pipe, making the product more efficient.

Additional tangential force on the shoe is transmitted to the pipe, urging the pipe to rotate with the shoe and the rotator. Additional radial force on the shoe pushes the shoe into the pipe, causing the pipe to distort, and generates heat and friction.

Excessive radial force can distort the shape of the pipe and can damage the pipe interior, for example by scratching, spalling, and gouging the pipe interior. Also, excessive radial force wastes energy by generating heat and excess friction.

The force characteristics, between the rotator and the shoe of product 10, are illustrated in FIG. 4 and FIG. 5. FIG. 4 is a section view across line A-A in FIG. 3 of the product 10 in the assembled condition, prior to being inserted in the pipe.

In the assembled condition, shown in FIG. 4, the first surface component 31 is captured between the seat 22 and the second surface component 41. The first surface component 31 contacts the second surface component 41 near the midpoint of the second surface component. This arrangement enables the product to be inserted inside the pipe. A force 51 on the shoe is normal to the first surface component 31 and the second surface component 41 where they contact each other.

In FIG. 5, the product 10 is shown inserted in the pipe 60 and with the rotator rotated so that the shoes have engaged the pipe. The first surface component 31 has traveled across the second surface component 41 toward the end of the second surface component. A force 52 is normal to the first surface component 31 and the second surface component 41 where they contact, and the forcing direction has turned more tangential than the forcing direction of the force 51 shown in FIG. 4. Turning the forcing direction more tangential minimizes the increase in radial force after the shoe engages the pipe and helps the product transmit more tangential force to the pipe.

From FIG. 4 and FIG. 5, it is clear that the design of the mismatched curvilinear surfaces is effective in turning the forcing direction to minimize radial force and maximize tangential force transmitted to the pipe. Any other configuration of contacting surfaces, such as a rectangular and polygonal configuration, would not turn the forcing direction more tangential to the degree provided by the mismatched curvilinear surfaces of the product. Any other configuration of contacting surfaces would not reduce the ratio of radial force to tangential force on the shoe to the degree provided by the curvilinear surfaces of the product.

In FIG. 6, the product 20 has three jaws 21A, a curvilinear first surface comprising three first surface components 31A, and a rotator. The product 20 has a shoe comprising three shoe components. In this embodiment, a shoe comprises the first surface component 31A and the jaw 21A because they move outward from the rotator when the rotator rotates. The rotator has a non-similar curvilinear second surface comprising three second surface components 41A.

The force characteristics, between the rotator and the shoe of the product 20, are illustrated in FIG. 7 and FIG. 8. FIG. 7 is a section view across line B-B in FIG. 6 of the product 20 in the assembled condition, prior to being inserted in the pipe. FIG. 8 is a similar section view of the product inserted in the pipe 60 and with the rotator rotated so that the shoes have engaged the pipe.

In FIG. 7 the second surface component 41A contacts the first surface component 31A near the midpoint of the first surface component. This arrangement enables the product to be inserted inside the pipe. A force 51A on the shoe is normal to the first surface component 31A and the second surface component 41A where they contact each other.

In FIG. 8, the product 20 is shown inserted in the pipe 60 and with the rotator rotated so that the shoes have engaged the pipe. The second surface component 41A has traveled across the first surface component 31A toward the end of the first surface component. A force 52A is normal to the first surface component 31A and the second surface component 41A where they contact, and the forcing direction has turned more tangential than the forcing direction of the force 52A shown in FIG. 7. Turning the forcing direction more tangential minimizes the increase in radial force after the shoe engages the pipe and helps the product transmit more tangential force to the pipe.

From FIG. 7 and FIG. 8, it is clear that the design of the mismatched curvilinear surfaces is effective in turning the forcing direction to minimize radial force and maximize tangential force transmitted to the pipe. Any other configuration of contacting surfaces, such as a rectangular and polygonal configuration, would not turn the forcing direction more tangential to the degree provided by the mismatched curvilinear surfaces of the product. Any other configuration of contacting surfaces would not reduce the ratio of radial force to tangential force on the shoe to the degree provided by the curvilinear surfaces of the product.

The product comprises at least one curvilinear first surface and at least one non-similar curvilinear second surface. The first surface can be concave and convex. The second surface can be concave and convex. The first surface can have more than one first surface component, and the second surface can have more than one second surface component. The product can have more than one first surface and more than one second surface. The first surface can contact one or more second surfaces. Alternatively, the second surface can contact one or more first surfaces.

The curvilinear surface can be a separate entity as shown in FIG. 3 and FIG. 9, where the curvilinear surface is cylindrical. Alternatively, the curvilinear surface can be spherical and spheroidal.

In FIG. 9, the product 30 comprises two jaws 21B, with two inward-facing seats 22B, a curvilinear first surface with two first surface components 31B, and a rotator. The product 30 has a shoe comprising two shoe components. In this embodiment a shoe comprises the jaw 21B, the seat 22B, and the first surface component 31B, because they move outward from the rotator when the rotator rotates. The rotator has a non-similar curvilinear second surface with two second surface components 41B.

In the assembled condition, shown in FIG. 10, the first surface component 31B is captured between the seat 22B and the second surface component 41B.

The force characteristics, between the rotator and the shoe of product 30, are similar to those of the product 10.

The shoe can have more than one shoe component. The products 10, 20 each have three shoe components. The product 30 has two shoe components. Other product configurations can have one, two, three or more shoe components.

The shoe has an outward-facing surface that engages the pipe interior. The jaws 21, 21A, 21B have machined outward-facing surfaces. The outward-facing surfaces can have various configurations. For example, the outward-facing surface can be machined, knurled, and ground. Abrasives can be applied to the outward-facing surface in various ways, such as by embedding in the surface and by bonding with adhesives.

The outward-facing surface can have various shapes. The jaws 21, 21A, 22A have outward-facing surfaces shaped substantially cylindrically for engaging the cylindrical pipe interior. Alternatively, the outward-facing surface can have two or more discrete engagement points, a continuous surface, and combinations thereof.

The shoe can have segmented jaws as in products 10, 20, and 30. Alternatively, the shoe can have jaws that encircle the rotator. Alternatively, the shoe can have jaws stacked axially along the rotator length. Various shoe configurations can be used, so long as the shoe is moved outward from the rotator by the action of contacting non-similar curvilinear surfaces, as described. The product can have more than one shoe.

The rotator can have a shaft extending from the curvilinear surface. The products 10, 20, and 30, have a cylindrical shaft 12.

The rotator can have a connecter for rotating the rotator from outside the pipe. The connecter can have various configurations; such as a male square drive feature, a hexagonal drive socket, a knurled feature, a T-slot, and combinations thereof. Alternatively, the connecter can be any feature that enables rotating from outside the pipe. In FIG. 1, the connecter is the square drive socket 13.

The product can have a depth controller for controlling how deep the product is inserted into the pipe. As shown in FIGS. 1, 2, 3, 6, and 9, the depth controller is an adjustable collar 14. The collar 14 is designed to slide along the shaft of the rotator. The collar 14 can be fixed in place by a setscrew. Various other methods for controlling the depth of insertion can be used.

The product can have means for limiting the axial movement and the radial movement of the shoe. In FIGS. 1, 3, 6, and 9, the shoe movement is limited axially and limited radially by a lower cap 15 and an upper cap 16. In use, the upper cap and lower cap hold the shoe in the assembled condition.

The upper cap and lower cap are designed to enable the shoe to collapse inward so that it can be inserted in the pipe, and permit the shoe to expand outward so that it can engage the interior of the pipe. Various other methods for limiting the axial movement and the radial movement of the shoe can be used.

The lower cap 15 fits over the rotator and rests on a shoulder at the end of the shaft 12. The lower cap has a circular pocket that captures the flange 23, 23A, 23B, on the end of the jaw 21, 21A, 21B.

The upper cap 16 sits against the end of the rotator. The upper cap has a circular pocket that captures the flange 24, 24A, 24B, on the end of the jaw 21, 21A, 21B.

The upper cap can be held in place by a fastener 80 and by various other methods such as a clip, a resilient element, by magnetic means, by threading the upper cap and the rotator, and combinations thereof.

1. An interiorly engaging pipe wrench product having force transmission elements devised to minimize distortion of a pipe, the product comprising:
a rotator;
a shoe,
the shoe contacting the rotator across a curvilinear first surface and at a non-similar curvilinear second surface; and
a curvature mis-match between the first surface and the second surface, the mis-match having been devised in order to minimize the increase in radial force on the pipe after the shoe engages the pipe.

2. The product of claim 1 wherein the first surface is concave.

3. The product of claim 1 wherein the first surface is convex.

4. The product of claim 1 wherein the first surface is cylindrical.

5. The product of claim 1 wherein the first surface is spherical.

6. The product of claim 1 wherein the first surface is spheroidal.

7. The product of claim 1 wherein the shoe comprises:
a plurality of shoe components,
any shoe component from the plurality of shoe components being interchangeable with any other shoe component from the plurality of shoe components.

8. An interiorly engaging pipe wrench product having force transmission elements devised to minimize distortion of a pipe, the product comprising:
a rotator having a curvilinear first surface;
a shoe,
the shoe comprising:
a non-similar curvilinear second surface;
a seat for positioning the second surface;
an outward-facing surface for interiorly engaging the pipe;
the shoe contacting the rotator across the first surface and at the second surface; and
a curvature mis-match between the first surface and the second surface,
the mis-match having been devised in order to minimize the increase in radial force on the pipe after the shoe engages the pipe.

9. The product of claim 8 wherein the second surface is concave.

10. The product of claim 8 wherein the second surface is convex.

11. The product of claim 8 wherein the second surface is cylindrical.

12. The product of claim 8 wherein the second surface is spherical.

13. The product of claim 8 wherein the second surface is spheroidal.

14. An interiorly engaging pipe wrench product having force transmission elements devised to minimize distortion of a pipe, the product comprising:
a rotator;
a shoe,
the shoe comprising a plurality of shoe components,
any shoe component from the plurality of shoe components being interchangeable with any other shoe component from the plurality of shoe components;
a first surface comprising:
a plurality of curvilinear first surface components,
any first surface component from the plurality of first surface components being interchangeable with any other first surface component from the plurality of first surface components;
a second surface comprising:
a plurality of curvilinear second surface components,
any second surface component from the plurality of second surface components being interchangeable with any other second surface component from the plurality of second surface components,
any second surface component from the plurality of second surface components being curvilinearly non-similar to any first surface component from the plurality of first surface components;
the shoe contacting the rotator across at least one curvilinear first surface component and at at least one non-similar curvilinear second surface component; and
a curvature mis-match between the first surface component and the second surface component,
the mis-match having been devised in order to minimize the increase in radial force on the pipe after the shoe engages the pipe.

15. The product of claim 14 wherein any first surface component is cylindrical.

16. The product of claim 14 wherein any first surface component is spherical.

17. The product of claim 14 wherein any first surface component is spheroidal.
